(19) United States
(12) Patent Application Publication
(10) Pub. No.: US 2014/0074553 A1
(43) Pub. Date: Mar. 13, 2014

(54) SYSTEM AND METHOD FOR CONSTRUCTING SPATIALLY CONSTRAINED INDUSTRY-SPECIFIC MARKET AREAS

(71) Applicant: TrueCar, Inc., Santa Monica, CA (US)

(72) Inventor: Thomas J. Sullivan, Santa Monica, CA (US)

(73) Assignee: TrueCar, Inc., Santa Monica, CA (US)

(21) Appl. No.: 14/026,111

(22) Filed: Sep. 13, 2013

Related U.S. Application Data
(60) Provisional application No. 61/700,704, filed on Sep. 13, 2012.

(51) Int. Cl. G06Q 30/02

(52) U.S. Cl. CPC G06Q 30/0203
USPC 705/7.29

(57) ABSTRACT

Disclosed is a new methodology for defining fixed industry-specific market areas (ISMAs). A system implementing an ISMA construction algorithm may extract relevant primary geographic polygon (PGP) data and operate to optimize a predefined industry-specific objective function, given relevant constraints such as the spatial relationships between PGPs and their adjacencies, industry-specific constraints such as the number of sales, and non-industry-specific constraints such as median household income. A PGP represents an undividable geographic administrative unit such as counties, states, Census tracts, 5-digit or 3-digit ZIP Codes, etc. A set of ISMAs may be constructed using a hierarchical PGP merging process in which PGPs are merged iteratively until a stopping condition is met. An iterative PGP swapping process may be employed to adjust the outcome from the hierarchical PGP merging process to achieve the best possible outcome for the objective function.

### CROSS-REFERENCE TO RELATED APPLICATION(S)

This is a conversion of, and claims a benefit of priority from U.S. Provisional Application No. 61/700,704, filed Sep. 13, 2012, entitled, “SYSTEM AND METHOD FOR CONSTRUCTING SPATIALLY CONSTRAINED INDUSTRY-SPECIFIC MARKET AREAS,” which is fully incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to market analysis and, particularly, to constructing spatially constrained industry-specific market areas.

### BACKGROUND OF THE RELATED ART

When the customer base of a firm selling a good or service increases in size, there is often an accompanying larger geographic area from which sales originate. Such a large geographic area can be partitioned into smaller sub-areas such as sales territories, regions, or metropolitan clusters.

Example partitioning approaches include the Designated Market Area (DMA) created by the Nielson Company to serve media broadcasting needs, U.S. Census division and regions (comprising groups of adjacent states), and Consolidated or Metropolitan Statistical Areas used by U.S. federal agencies. Each of the partitions in these examples build clusters of adjacent land areas whose boundaries are defined by some undividable geographic administrative unit (e.g., counties, states, Census tracts, three-digit ZIP codes, etc.).

However, with an erosion of administrative boundaries as a barrier for geographic expansion of sales, increasingly efficient methods for distribution of goods and services, the growth of internet commerce, and emerging and observable differences in the behavior of consumers related to their geographic location, there arises a need for organizations within a particular industry to partition their areas of influence into more useful and distinct areas.

For example, in the case of the automotive industry, a buyer in Manhattan might have different needs or desires than a buyer in Midland, Tex. A properly-defined partitioning outcome can allow a seller to more particularly focus on the potential buyers within the respective market areas. That is, it can be used to support geo-targeted marketing, within-brand differentiation in product and presentation, and generate analytics with actionable information based on observed geo-specific behavior.

While Nielson's DMA approach defines clusters of designated market areas, these are for a specific industry—broadcasting—and the collection of DMAs do not cover the entire U.S. population. Thus, the Nielson DMA is inapplicable to other industries or organizations that might desire or need to define industry-specific market areas over large territories.

### SUMMARY OF THE DISCLOSURE

Embodiments disclosed herein provide a new methodology for defining fixed industry-specific market areas (ISMAs). Such fixed ISMAs may be updated infrequently, if at all, depending upon a specific industry. For example, in the automotive industry, ISMAs may be updated once a year or at a predetermined time interval.

In some embodiments, a Primary Geographic Polygon (PGP) is defined as some undividable geographic administrative unit (e.g., counties, states, Census tracts, 5-digit or 3-digit ZIP Codes, etc.). In many cases, the complete set of PGPs for a particular organization fills the entirety of geographic space being partitioned. The term Market Area (MA) may be used to define the final partitioning of the entire geographic space and may construct these using a hierarchical approach in which PGPs are merged iteratively using a pre-defined set of rules until a stopping condition (e.g., a threshold) is met.

In one embodiment, a hierarchical approach is taken that begins with known PGP boundaries and combines or merges them into larger polygons which fill the geographic area of interest (AOI) of the user. In some embodiments, a rule set for constructing ISMAs can include three components: (1) the spatial relationships between PGPs, such as the distances among them, their adjacencies, and existing terrain-based obstacles and accessibility among PGPs; (2) the demographic characteristics of the population residing in each PGP; and (3) the historical behavior of residents of each PGP as it relates to a specific industry.

Using these three components, ISMAs can be defined for use by organizations whose sales span large areas. ISMAs are not specific to any particular product. In the detailed description that follows, the methodology is described at the industry-level in a manner such that it can be used uniformly for all firms operating in that industry. However, as any firm within an industry whose objective function or geographic area of interest (AOI) may differ significantly from the overall industry, the teachings of embodiments disclosed herein may be tailored or otherwise implemented to be more firm-specific.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts one embodiment of a topology including a vehicle data system.

FIG. 2 depicts a flow diagram illustrating one example embodiment for vehicle pricing using industry-specific market areas (ISMAs).

FIG. 3 depicts a flow diagram illustrating one example method for determining ISMAs.

FIG. 4 depicts a diagrammatic representation of a system implementing an example embodiment of the method of FIG. 3.

FIG. 5 depicts an example region with example Primary Geographical Polygons (PGPs).

FIG. 6 depicts an exemplary initial merging of PGPs.

FIG. 7 depicts exemplary clustering of PGPs.

FIG. 8 depicts an exemplary initial cluster of PGPs.

FIG. 9 depicts exemplary adjustments of an initial clustering.

FIG. 10 depicts further exemplary adjustments to an initial clustering.

FIG. 11 depicts an exemplary adjusted clustering.

FIG. 12 depicts an exemplary portal for a web site using an embodiment of the methodology disclosed herein.

FIG. 13 depicts an exemplary portal for a web site using an embodiment of the methodology disclosed herein.

FIG. 14 depicts an exemplary portal for a web site using an embodiment of the methodology disclosed herein.

FIG. 15 depicts exemplary Industry Specific Market Areas specific to an industry.

### DETAILED DESCRIPTION

The disclosure and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a HD), hardware circuitry or the like, or any combination.

Before discussing specific embodiments, a brief overview of the context of the disclosure may be helpful.

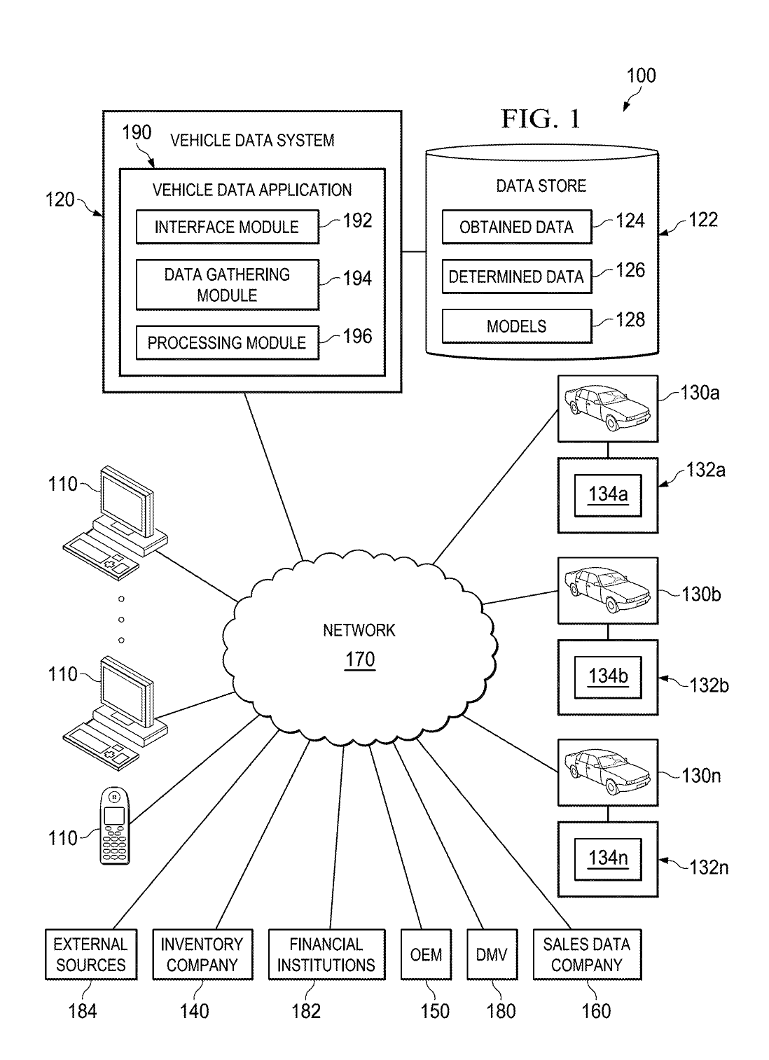

FIG. 1 depicts one embodiment of a topology which may be used to implement embodiments of the systems and methods disclosed herein. Topology 100 comprises a set of entities including vehicle data system 120 (also referred to herein as the TrueCar system) which is coupled through network 170 to computing devices 110 (e.g., computer systems, personal data assistants, kiosks, dedicated terminals, mobile telephones, smart phones, etc.), and one or more computing devices at inventory companies 140, original equipment manufacturers (OEM) 150, sales data companies 160, financial institutions 182, external information sources 184, departments of motor vehicles (DMV) 180 and one or more associated point of sale locations, in this embodiment, car dealers 130a . . . n. Computing devices 110 may be used by consumers while conducting a search for consumer goods and/or services, such as automobiles. Network 170 may be for example, a wireless or wired communication network such as the Internet or wide area network (WAN), publicly switched telephone network (PTSN) or any other type of electronic or non-electronic communication link such as mail, courier services or the like.

Vehicle data system 120 may comprise one or more computer systems with central processing units executing instructions embodied on one or more computer readable media where the instructions are configured to perform at least some of the functionality associated with embodiments disclosed herein. These applications may include a vehicle data application 190 comprising one or more applications (instructions embodied on one or more non-transitory computer readable media) configured to implement an interface module 192, data gathering module 194 and processing module 196 utilized by the vehicle data system 120. Furthermore, vehicle data system 120 may include data store 122 operable to store obtained data 124, data 126 determined during operation, models 128 which may comprise a set of dealer cost model or price ratio models, or any other type of data associated with embodiments disclosed herein or determined during the implementation of those embodiments.

Vehicle data system 120 may provide a wide degree of functionality, including utilizing one or more interfaces 192 configured to, for example, receive and respond to queries from users at computing devices 110; interface with inventory companies 140, manufacturers 150, sales data companies 160, financial institutions 182, DMVs 180 or dealers 130 to obtain data; or provide data obtained, or determined, by vehicle data system 120 to any of inventory companies 140, manufacturers 150, sales data companies 160, financial institutions 182, DMVs 180, external data sources 184 or dealers 130. It will be understood that the particular interface 192 utilized in a given context may depend on the functionality being implemented by vehicle data system 120, the type of network 170 utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, or almost any other type of interface which it is desired to utilize in a particular context.

In general, then, using these interfaces 192 vehicle data system 120 may obtain data from a variety of sources, including one or more of inventory companies 140, manufacturers 150, sales data companies 160, financial institutions 182, DMVs 180, external data sources 184 or dealers 130 and store such data in data store 122. This data may be then grouped, analyzed or otherwise processed by vehicle data system 120 to determine desired data 126 or models 128 which are also stored in data store 122.

A user at computing device 110 may access the vehicle data system 120 through the provided interfaces 192 and specify certain parameters, such as a desired vehicle configuration or incentive data the user wishes to apply, if any. The vehicle data system 120 can select a particular set of data in the data store 122 based on the user specified parameters, process the set of data using processing module 196 and models 128, generate interfaces using interface module 192 using the selected data set on the computing devices 110 and data determined from the processing, and present these interfaces to the user at the user's computing device 110. Interfaces 192 may visually present the selected data set to the user in a highly intuitive and useful manner.

A visual interface may present at least a portion of the selected data set as a price curve, bar chart, histogram, etc. that reflects quantifiable prices or price ranges (e.g., “average,” “good,” “great,” “overpriced,” etc.) relative to reference pricing data points (e.g., invoice price, MSRP, dealer cost, market average, internet average, etc.). Using these types of visual presentations may enable a user to better understand the pricing data related to a specific vehicle configuration. Additionally, by presenting data corresponding to different vehicle configurations in a substantially identical manner, a user can easily make comparisons between pricing data associated with different vehicle configurations. To further aid the understanding for a user of the presented data, the interface may also present data related to incentives which were utilized to determine the presented data or how such incentives were applied to determine presented data.

Turning to the various other entities in topology 100, dealers 130a . . . n may include a retail outlet for consumer goods and/or services, such as vehicles manufactured by one or more of OEMs 150. To track or otherwise manage sales, finance, parts, service, inventory and back office administration needs, a dealer may employ a dealer management system (DMS) (e.g., DMS132a . . . n). Since many DMSs are Active Server Pages (ASP) based, transaction data (transaction data 134a . . . n) may be obtained directly from the DMS with a “key” (for example, an ID and Password with set permissions within the DMS system) that enables data to be retrieved from the DMS. Many dealers may also have one or more web sites which may be accessed over network 170, where pricing data pertinent to the dealers may be presented on those web sites, including any pre-determined, or upfront, pricing. This price is typically the “no haggle” price (i.e., price with no negotiation) and may be deemed a “fair” price by vehicle data system 120.

Inventory companies 140 may be one or more inventory polling companies, inventory management companies or listing aggregators which may obtain and store inventory data from one or more of dealers 130a . . . n (for example, obtaining such data from DMS 132a . . . n). Inventory polling companies are typically commissioned by the dealer to pull data from a DMS and format the data for use on websites and by other systems. Inventory management companies manually upload inventory information (photos, description, specifications) on behalf of the dealer. Listing aggregators get their data by “scraping” or “spidering” websites that display inventory content and receiving direct feeds from listing websites (for example, AutoTrader.com, FordVehicles.com, etc.).

DMVs 180 may collectively include any type of government entity to which a user provides data related to a vehicle. For example, when a user purchases a vehicle it must be registered with the state (for example, DMV, Secretary of State, etc.) for tax and titling purposes. This data typically includes vehicle attributes (for example, model year, make, model, mileage, etc.) and sales transaction prices for tax purposes.

Financial institution 182 may be any entity such as a bank, savings and loan, credit union, etc. that provides any type of financial services to a participant involved in the purchase of a vehicle. For example, when a buyer purchases a vehicle, they may utilize a loan from a financial institution, where the loan process usually requires two steps: applying for the loan and contracting the loan. These two steps may utilize vehicle and consumer information in order for the financial institution to properly assess and understand the risk profile of the loan. Typically, both the loan application and loan agreement include proposed and actual sales prices of the vehicle.

Sales data companies 160 may include any entities that collect any type of vehicle sales data. For example, syndicated sales data companies aggregate new and used sales transaction data from DMSs of particular dealers. These companies may have formal agreements with certain dealers that enable them to retrieve data from the dealers in order to syndicate the collected data for the purposes of internal analysis or external purchase of the data by other data companies, dealers, and OEMs.

Manufacturers 150 can be those entities which actually build the vehicles sold by dealers 130a . . . n. To guide the pricing of their vehicles, manufacturers 150 may provide an Invoice price and a Manufacturer's Suggested Retail Price (MSRP) for both vehicles and options for those vehicles—to be used as general guidelines for the dealer's cost and price. These fixed prices are set by the manufacturer and may vary slightly by geographic region.

External information sources 184 may comprise any number of other various source, online or otherwise, which may provide other types of desired data, for example data regarding vehicles, pricing, demographics, economic conditions, markets, locale(s), consumers, etc.

It should be noted here that not all of the various entities depicted in topology 100 are necessary, or even desired, in embodiments disclosed herein, and that certain of the functionality described with respect to the entities depicted in topology 100 may be combined into a single entity or eliminated altogether. Additionally, in some embodiments other data sources not shown in topology 100 may be utilized. Topology 100 is therefore exemplary only and should in no way be taken as imposing any limitations on embodiments disclosed herein.

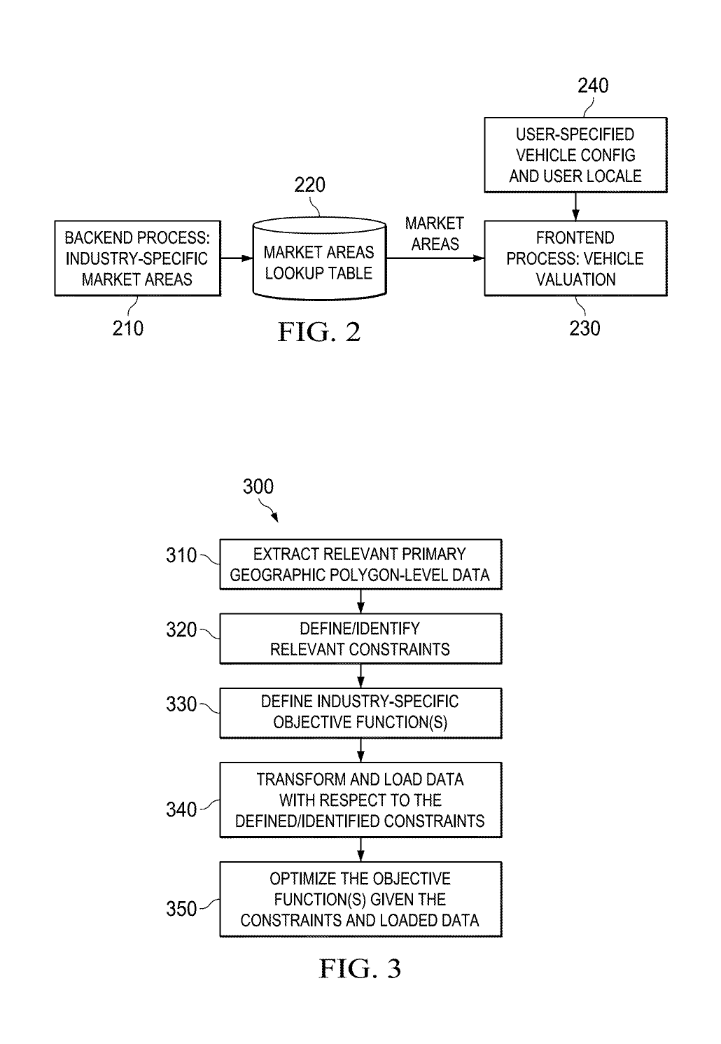

FIG. 2 depicts an example scenario illustrating how some embodiments of a vehicle data system (e.g., vehicle data system 120 shown in FIG. 1) may implement a vehicle pricing model that utilizes industry-specific market areas (ISMAs). As illustrated in FIG. 2, in some embodiments, a vehicle data system may perform offline calculations and compute ISMAs in backend process 210. These ISMAs can be computed independently of any particular product or user, and stored and persisted in lookup table 220 for later use, for instance, in frontend vehicle valuation process 230. In some embodiments, frontend vehicle valuation process 230 may, in response to user query 240 on a particular vehicle configuration, access lookup table 220 and dynamically, in real time, select an appropriate pre-computed ISMA based on user-specified information such as user locale.

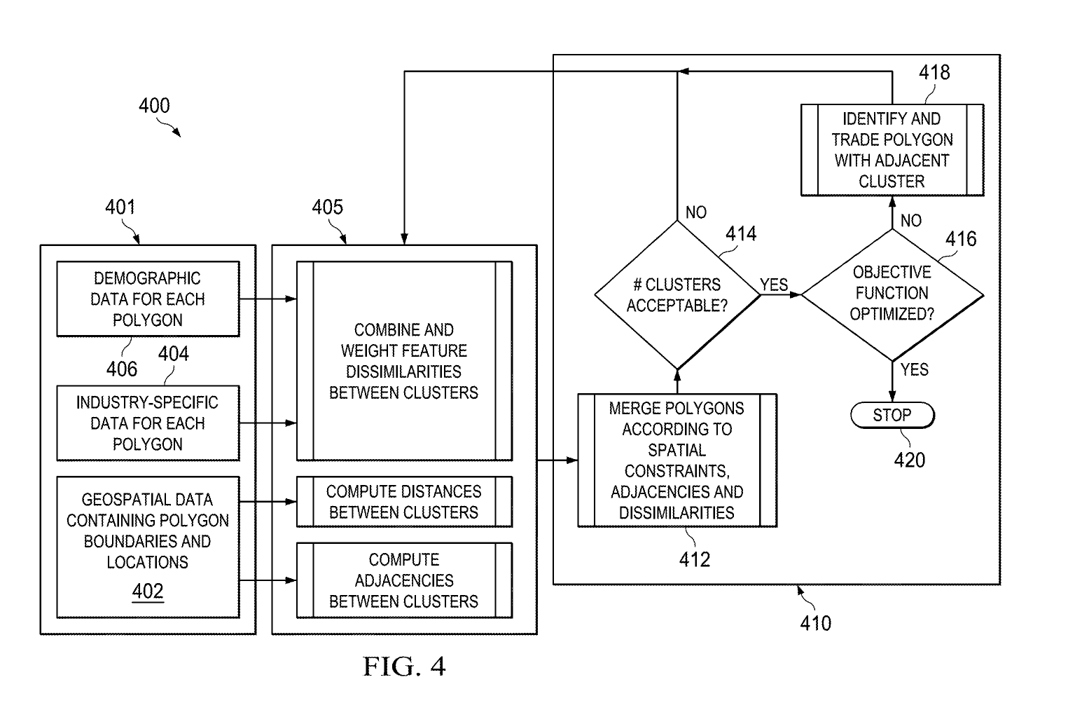

FIG. 3 depicts a flow diagram illustrating one example methodology for determining ISMAs. Backend process 300 of FIG. 3 may be one example embodiment of backend process 210 of FIG. 2. FIG. 4 depicts a diagrammatic representation of system 400 implementing an example embodiment of backend process 300. An overview of the methodology, therefore, will be provided below with reference to both FIGS. 3 and 4.

In some embodiments, backend process 300 may implement an ISMA construction algorithm for determining ISMAs. The ISMA construction algorithm may include five major sequential steps for merging PGPs: extract relevant Primary Geographic Polygon-level data (step 310), define/identify relevant constraints (step 320), define industry-specific objective function(s) (step 330), transform and load data with respect to the defined/identified constraints (step 340), and optimize the objective function(s) given the constraints and loaded data (step 350).

Step 310—The extraction of relevant Primary Geographic Polygon (PGP)-level data needed to inform the ISMA construction. Referring to FIG. 4, this may include geospatial polygon data 402 (e.g., boundaries, hydrology layers, terrain layers, road networks, etc.); industry-specific data 404 that captures buyer behaviors, their preferences, and the historical interactions between buyer and seller in each PGP; and (optional) non-industry-specific data 406 (e.g., demographics) describing the population that purchase goods or services within the industry's overall area of interest (AOI). In one embodiment, system 400 may include data extraction module 401 implementing part of the ISMA construction algorithm. Data extraction module 401 may be embodied on a non-transitory computer readable medium configured for extracting or otherwise obtaining geospatial polygon data 402, industry-specific data 404, and non-industry-specific data 406.

Step 320—Identification and/or definition of relevant constraints that need to be imposed on the possible solutions. The number and types of constraints may vary from industry to industry, depending upon the product and/or target of interest. For example, referring to FIG. 4, a spatial constraint for the automotive industry could be adjacency of clusters. That is, PGPs will not be merged if they are not physically adjacent. Another constraint may be the distances between clusters. Some constraints may be non-industry-specific. An example of a non-industry-specific constraint could be that two PGPs will not be merged if annual household income differs by more than, say, $10,000. In general, the constraints are devised so as to ensure that the PGPs that are merged have similar behavior characteristics. Another could be setting a desired or acceptable (approximate) number of final ISMAs. Referring to FIG. 4, in one embodiment, system 400 may further include constraint computation module 405 implementing part of the ISMA construction algorithm. Constraint computation module 405 may be embodied on a non-transitory computer readable medium configured for determining relevant constraints, including computing adjacencies between clusters, computing distances between clusters, and combining and weighing feature dissimilarities between clusters, as explained in detail below.

Step 330—Definition of the industry-specific objective function(s) that need to be achieved via the construction of the PGP. For example, the ultimate set of ISMAs should also be chosen so as to ensure that each ISMA has data. In the case of the automotive industry, if the ISMAs are provided to users on a web site, a goal is to minimize the number of user searches for which there is no data. As a specific example, an industry-specific objective function may be that each ISMA should have at least 20 vehicle sales transactions.

Step 340—Transformation and loading of the data with respect to the defined constraints. This transformation process can normalize data, including non-numeric data, so that the similarity between PGPs can be quantified. In one embodiment, a goal is to determine a score defining the similarity between PGPs. In some embodiments, if the degree of similarity is within a threshold, they won't be combined. In other instances, given a first PGP and two others if the similarity scores are all within the threshold, the most similar two will be combined.

Step 350—Execution of an optimization algorithm that seeks to globally optimize the objective function given the constraints and loaded data. In one embodiment, the optimization algorithm may be part of the ISMA construction algorithm. Referring to FIG. 4, in one embodiment, system 400 may further include an objective function optimization module 410 implementing the optimization algorithm. Objective function optimization module 410 may be embodied on a non-transitory compute readable medium configured for merging PGPs according to the computed spatial constraints, adjacencies, and dissimilarities (step 412) and determining whether an industry-specific objective function has been met (step 414). This provides an initial/current solution. Objective function optimization module 410 may further operate to determine whether the current solution is an optimized one (step 416). If not, objective function optimization module 410 may further operate to refine the current solution according to updated similarity constraints, in which PGPs are traded/swapped into and out of already combined adjacent clusters (step 418). The PGPs are combined and refined via this iterative process until a number of ISMAs approximating the desired or acceptable number is obtained (step 420). In some embodiments, a cluster including multiple PGPs will have constraints that differ from those of individual PGPs.

These steps are discussed in greater detail below.

1. Extraction of Relevant Primary Geographic Polygon-Level Data

Data for each Primary Geographic Polygon (PGP) is extracted during the first step. Naturally, extraction of the polygons covering the entire earth is not always necessary, and so the data that cover the user's area of interest (AOI) are sufficient. Preferably, data should be available for all three classes (spatial, industry-specific, and non-industry specific) in order for the ISMA methodology to be used. The choice of the term “primary” is chosen to imply that the geographic unit used for the ISMA methodology is the smallest geographic unit for which all classes of data are available. For example, if the spatial data is available at the U.S. Census Block level, but the other types of data are only available at the U.S. Census Tract Level (a lower level of resolution such that Census Blocks are elements of a Census Tract), then the PGP would necessarily be at the Tract level.

Spatial Polygon Data (S): Geospatial data is widely available from many government agencies, universities, and mapping software vendors. Though the data may be stored as images, text files, or other formats, in some embodiments, a standard shapefile is used in the construction of ISMAs. Shapefiles are either lines, points, or polygons and it is the polygon components that are used in the ISMA methodology. The standard polygon shapefile will include the latitude and longitude of the boundary points of each polygon, the geo-centers of each polygon, and a means for identifying which these points are associated with a specific polygon.

Additionally, since the geographic distances between polygons (or their individual points) are often relevant, the format of the latitude and longitudes should be amenable to computing the Great Circle Distance (GCD) between points on a sphere. It is noted that regardless of the format in which the geographic data is stored, in some embodiments the ISMA methodology use latitude and longitude of the boundary points of each polygon, the geo-centers of each polygon, and a means to determine if any two polygons in the dataset share one or more points. It is further noted that, while in some embodiment, latitude and longitude are used, other geographical coordinate systems may be employed.

Depending on the industry in which the ISMAs are being computed, additional layers (also shapefiles) may be relevant when they relate to the way in which the goods and services are provide to the customer. For example, if railways, roadways, airways, or waterways are used to distribute the good or service, knowledge of the distribution network may be determined by using the appropriate layers (e.g., hydrology, transportation, airway hubs, etc.). For purposes of illustration, it will be assumed that the existing road network will be used to distribute goods or services (e.g., Google Maps, Yahoo Maps, ESRI shapefiles, Bing Maps, or the OpenStreetNetwork project all have the capability to determine drive time—given tolls, ferries, capacity, and average speed—and drive distance between any two terrestrial points).

Industry-Specific Data (C): Any data available at the PGP level that is industry-specific is included in this class and may contain information such as the number of sales, the product preferences of residents of the PGP, the ability for residents to access the information required to execute a transaction in the industry (internet usage, legal restrictions, etc.), changes in the customer base (“product churn” relating to individuals who shift preferences or sales outlets), the projected lifetime value (LTV) associated with convincing the potential customer to acquire goods and services within the industry, etc. These data are less commonly available and may be acquired from vendors of marketing information, industry trade groups, or firms operating in the industry.

Non-Industry-Specific Data (B): Any non-spatial data at the PGP level that is not specific to industry yet deemed to be relevant to intent of the partitioning exercise are included in this category. Examples would include socio-economic data such as median household income, median housing price, unemployment, degree of urbanicity, percent of adult (18 years or older) residents holding a high school degree, etc. The U.S. Census Bureau collects and makes available these data based on the full enumeration of the population resulting from their decennial census. Other relevant data may be collected more frequently and, where available at the PGP level, more current data should be used if the purpose of the ISMA construction will support future decision-making.

The full set of data, X, can be then represented in matrix form as;

X=S∪C∪B such that {(S∩C),(S∩B),(C∩B)}= [Equation 1]

2. Identification of Relevant Constraints (Λ)

Without constraints, undesirable outcomes may result during the construction of PGPs. The most important decision in this step is to identify how many partitions, K, are desired. If there are n PGPs, then the ISMA process only becomes useful if 1<K<n. The choice of K could be determined based on business reasons (e.g. divide the AOI into no more than K sales regions) or by usability of the resulting ISMAs. Since there is purpose behind the choice to partition the AOI, it is unlikely that selection of K that is very close to n (unless n is small) would provide any non-negligible value.

Beyond the choice of K, other constraints may be placed on the spatial, industry-specific, non-industry specific classes of data that would limit merging of PGPs if the members of the resulting ISMAs would result in within-partition characteristics that are highly dissimilar. Partitioning of data in this context is equivalent to statistical clustering—the terms “cluster” and “partition” are interchangeable—where the goal is to jointly maximize (with respect to the data) the between-cluster variation while minimizing the within-cluster variation.

Without constraining the merging criteria with respect to a choice of K, it is possible that the desired balance between the variance components is not achieved. Examples of constraints could be spatial (e.g. the maximum radial distance between any two points in a cluster of 2 or more PGPS can not exceed a certain limit), or tied to some of the other data classes (e.g., the difference between the median household income of all pairs of PGPs in an cluster can not exceed $10,000). Choice of these constraints is often guided by business decisions (e.g., it is undesirable to combine PGPs with radically different income profiles as the geo-targeted marketing campaign will be influenced by the income levels of the members of the ISMA).

In some embodiments, an important spatial constraint may be that no two PGPs may belong to the same cluster if they are not adjacent to at least one other PGP in the cluster (unless the PGPs are themselves discontinuous, as in the case of an island or a isthmus). This constraint can ensure that all clusters contain contiguous PGPs and that another cluster need not be crossed to reach each of its members. This result may occur even without the imposition of the constraint, but such a result is otherwise not guaranteed. A discontinuous set of clusters would also defeat the spirit of the ISMA construction as the clustering goal is intended to minimize within-cluster variation along all data classes including the spatial class—a set of discontinuous PGPs in a cluster would seem to violate this aim.

An additional constraint ρ may be defined as the maximum distance allowable between any two PGPs in the same cluster. This constraint disallows any clustering outcome in which the inter-cluster distance is too far to travel (with respect to a road network, waterways, etc.).

It is noted that, given the set of constraints Λ, and underlying data, X, it may become impossible to achieve the desired number of partitions, K. If this outcome results, the user may consider relaxing constraints until the conditions allow an outcome consistent with the choice of K. Alternatively, the user may simply accept the number of clusters output.

3. Definition of the Objective Function

The set of p=1, . . . , P possible partitioning outcomes determined by the data X given constraints may be defined as:

Gₚ=f(X|Λ,K) [Equation 2]

and the objective function is used to determine which of the many possible partitioning outcomes will provide the most usefulness once used to support operations of the industry. For example, if the objective is to create ISMAs containing a roughly equal number of residents, the objective function would be:

G*=min(minₚΣₖ₌₁^{K}(Nₖ(p)− N̅(p)) subject to f(X|Λ,K) [Equation 3]

where Nₖ(p) is the number of customers in cluster given clustering outcome p and N̅(p) is the average number of customers given clustering outcome p.

4. Transformation and Loading of Data

In this step, the goal is to project the data X into a lower-dimensional space that will enable the clustering algorithm to be executed. As the goal of any clustering outcome, Gₚ, would be to select a set of clusters such that the within-cluster variance is minimized and the between-cluster variance is maximized, the implicit goal is to select members of a cluster that are most similar (with respect to X and constrained by Λ) or equivalently, least dissimilar.

The extracted data for PGPᵢ (i=1, . . . , n), xᵢ, can be described by its p=1, . . . m features (also known as characteristics or variables) represented in the three data classes presented earlier:

xᵢ={x_{i,1}, x_{i,2}, . . . , x_{i,m}} [Equation 4]

and all n distinct items may be represented in matrix form as

$$X = [ \begin{matrix}{x}_{1 , 1} & {x}_{1 , 2} & … & {x}_{1 , m - 1} & {x}_{1 , m} \\ {x}_{2 , 1} & {x}_{2 , 2} & … & {x}_{2 , m - 1} & {x}_{2 , m} \\ ⋮ & ⋮ & ⋱ & ⋮ & ⋮ \\ {x}_{n - 1 , 1} & {x}_{n - 1 , 2} & … & {x}_{n - 1 , m - 1} & {x}_{n - 1 , m} \\ {x}_{n , 1} & {x}_{n , 2} & … & {x}_{n , m - 1} & {x}_{n , m}\end{matrix} ] . \qquad [ Equation 5 ]$$

An example of the data layout is shown in Table 1 below.

TABLE 1
Example data matrix

| | | X | | | | | | | | | | | |
|---|---|---|---|---|---|---|---|---|---|---|---|---|---|
| PGP | | Spatial Geocenter | | Industry-Specific Data | | | | | Non-Industry-Specific Data | | | | |
| Identifier | Cluster | Latitude | Longitude | (C) | | | | | (C) | | | | |
| (i) | (k) | (s₁) | (s₂) | c₁ | c₂ | . . . | c_{m′-1} | c_{m′} | b₁ | b₂ | . . . | b_{m″-1} | b_{m″} |
| 1 | 1 | | | | | | | | | | | | |
| 2 | 2 | | | | | | | | | | | | |
| . . . | . . . | | | | | | | | | | | | |
| n − 1 | n − 1 | | | | | | | | | | | | |
| n | n | | | | | | | | | | | | |

The feature-specific dissimilarity between item i and item j based on a comparison of the r^{th} observable features, d_{ij,r} can be computed as:

$${d}_{ij , r} = \{ \begin{matrix}\vert {x}_{i , r} - {x}_{j , r} \vert & if \vert {x}_{i , r} - {x}_{j , r} \vert \leq {λ}_{r} \\ ∞ & if \vert {x}_{i , r} - {x}_{j , r} \vert > {λ}_{r}\end{matrix} \qquad [ Equation 6 ]$$

where λᵣ is the constraint placed on feature r. If no constraint exists, one may simply select λᵣ=∞ which is equivalent to not applying a constraint. λᵣ can be configurable and vary from implementation and implementation. For example, suppose λᵣ=2, if a distance d_{ij,r} between items i and j (an absolute value of x_{i,r}−x_{j,r}) for feature r is more than 2, r will not be considered as the dissimilarity between these items with respect to feature r is too great. Those skilled in the art will appreciate that, instead of minimizing feature-specific dissimilarities, some embodiments may focus on maximizing feature-specific similarities between items.

Although the format of the data for some options may not be numeric, (dis)similarity can still be established across features by first transforming the data to a numeric scale. For example, binary, ordinal, and categorical features may be transformed as set forth below:

Binary Features: When the possible states that a variable may assume is only two (e.g. yes/no, on/off, black/white, etc.), it can be mapped a numeric scale by setting one state to 1 and the other to 0. For example, the following rule could be applied to transform a feature represented as “yes”/“no” onto a numeric scale (The choice of which state gets assigned the value of 1 is unimportant as it does not affect the similarity computations):
if x_{i,r}=“yes” then x_{i,r}=1
if x_{i,r}=“no” then x_{i,r}=0.

Ordinal Features: When the values of a feature takes on a non-numeric format with an implied order (e.g., “Low”/“Medium”/“High”, “Poor”/“Fair/,” Good”) a simple transformation would represent the features using their ranks. For example, the following rule could be applied to transform a feature represented as “low”/“medium”/“high” onto a numeric scale (More complex transformations may be applied if information exists supporting the need to non-uniformly space the various states):
if x_{i,r}=“low” then x_{i,r}=1
if x_{i,r}=“medium” then x_{i,r}=2
if x_{i,r}=“high” then x_{i,r}=3.

All features that been transformed to a numeric format can then be rescaled or standardized over [0,1] as follows:

$${x}_{i , p} = \frac{( {x}_{i , p} - {min}_{i} {x}_{. , p} )}{( {max}_{i} {x}_{. , p} - {min}_{i} {x}_{. , p} )}$$

As an example, suppose the above transformation is applied to an automobile purchase in the “midsize car” category and the least expensive car in the category was $18,000 and the most expensive car in the category was $28,000. The scaled values of the price feature for the least expensive, most expensive, and a car in the category costing $26,000 would be:
Least Expensive: x_{i,p}=(18,000−18,000)/(28,000−18,000)=0/10,000=0.0
Most Expensive: x_{i,p}=(28,000−18,000)/(28,000−18,000)=10,000/10,000=1.0
$26,000 car: x_{i,p}=(26,000−18,000)/(28,000−18,000)=8,000/10,000=0.8.

Categorical Features: When the values of a feature take on a non-numeric format without an implied order (e.g., “Red”/“White”/“Green”), (dis)similarity for that feature across observations can still be established.

$${d}_{ij , r} = \{ \begin{matrix}1 & if {x}_{i , r} \neq {x}_{j , r} \\ 0 & if {x}_{i , r} = {x}_{j , r}\end{matrix} \qquad [ Equation 7 ]$$

With respect to the distance constraint placed on the spatial elements, then λᵣ=ρ and is applied to the computed distance between the latitudes and longitudes of PGPᵢ and PGPⱼ (or a similar distance metric that employs knowledge of the appropriate geospatial layers such as transportation networks). This example assumes that the maximum distance between PGPs is a function of the spacing between geocenters. However, one may extend this to include all points in the polygon by computing distances between the points that define the polygon boundaries or, if that is too computationally costly, by computing the distances between distances between randomly-generated points that lie within or on the boundaries of each polygon.

Since the spatial dissimilarity (distances between polygons) have been condensed into a single dimension, there are actually (m−1) dimensions in the transformed data=(1 (spatial)+m′ (industry-specific)+m″ (non-industry-specific)) and the spatial distance component is expressed by d_{ij,2}. An overall one-dimensional composite dissimilarity can then be computed using the using the well-known Minkowski metric:

dᵢⱼ=[Σᵣ₌₂^{m}wᵣd_{ij,r}^{γ}]^{1/γ}. [Equation 8]

where γ≧0 and Σᵣ₌₂^{m}wᵣ=1 and values of wᵣ are chosen by a subject matter analyst employing the methodology and reflect the relative importance of each feature in the determination of similarity.

Note that it is recommended that each set of d_{ij,r} be rescaled so that the smallest value across all pairs i/j is set equal to 0, the largest finite value is set equal to 1, and all values in between are rescaled linearly (preserving the ∞ values). The n×n matrix of PGP dissimilarities can then be defined as:

$$D = [ \begin{matrix}0 & {d}_{1 , 2} & … & {d}_{1 , n - 1} & {d}_{1 , n} \\ {d}_{2 , 1} & 0 & … & {d}_{2 , n - 1} & {d}_{2 , n} \\ ⋮ & ⋮ & ⋱ & ⋮ & ⋮ \\ {d}_{n - 1 , 1} & {d}_{n - 1 , 2} & … & 0 & {d}_{n - 1 , n} \\ {d}_{n , 1} & {d}_{n , 2} & … & {d}_{n , n - 1} & 0\end{matrix} ] \qquad [ Equation 9 ]$$

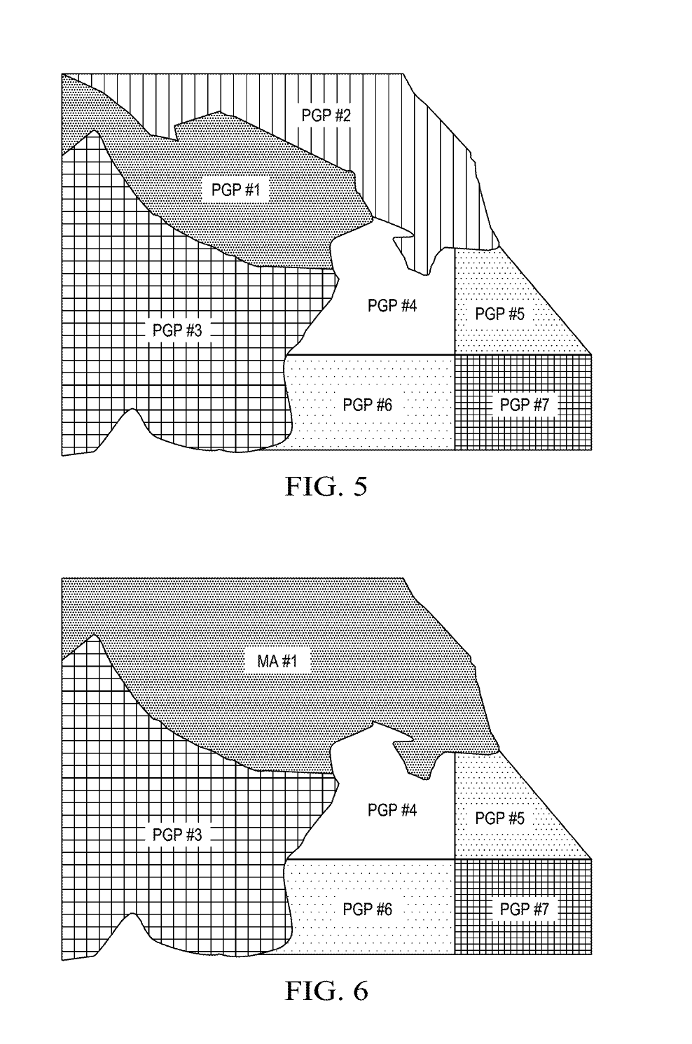

In order to facilitate the discussion of how the adjacencies between PGPs are computed, reference is made to the example data of FIG. 5.

FIG. 5 provides an example of a region in which industry-specific market areas (ISMA) may be defined. As will be discussed in greater detail below, according to some embodiments, an iterative approach is used, in which attributes of particular regions and combinations thereof are examined to determine a “best” partition. More particularly, some embodiments compare adjacent PGPs according to industry-specific criteria and allow merging of the PGPs if they meet the predetermined criteria. Once an initial merge has occurred, the newly merged region or regions are compared against adjacent non-merged regions to determine whether other regions or PGPs should be added or whether they should be un-merged.

In the example illustrated, the entire geographic space requiring portioning is presented as seven distinct and numbered Primary Geographic Polygons (PGP #1-PGP #7 shown in FIG. 5). As noted above, such PGPs may be predetermined indivisible regions (e.g., states, zip codes, cities, DMAs, etc.). It is noted, too, that FIG. 5 is exemplary only. In practice, more or fewer than seven PGPs may be defined in a particular prospective geographic space.

For example, in some embodiments, the basic PGP is the three-digit ZIP code. For example, in Austin, Tex., a three-digit ZIP code is 787XX, where XX are variable digits. If the area of interest is the entire United States, then the methodology according to embodiments begins with, and attempts to merge, 932 PGPs. The number of resulting ISMAs may be any number between 2 and K−1 of the PGPs, where K is the starting number of PGPs.

Many statistical computing and geospatial packages contain a function that allows an n×n adjacency matrix to be constructed such that a value of 1 in the i,j^{th} polygons are adjacent and a value of 0 indicates that they are not. The definition of adjacency is that two or more points in a pair of polygons indexed by i and j are adjacent if they share two or more boundary points. There are three considerations that need to made however: (1) A polygon is always adjacent to itself (the matrix should have 1's on the diagonal); (2) The precision of the instruments used to construct polygon boundaries are often imprecise; (3) Diagonal elements in a grid might be considered adjacent if they share only one point (see PGP #4 and PGP #7, for example).

Because of these considerations, it is often preferable to: (1) Populate the adjacency matrix with 1's along the diagonal after it is constructed using available tools in the software package; (2) Use the ‘snap’ function that allows for specification of small tolerance for imprecision (e.g. snap=100 meters); (3) Use the ‘queen’ method allowed by the software instead of the ‘rook’ which allows the adjacency condition to be met if only one snapped boundary point is shared between polygons.

For the example data, the adjacency matrix is:

$${A}_{0} = [ \begin{matrix}1 & 1 & 1 & 1 & 0 & 0 & 0 \\ 1 & 1 & 0 & 1 & 1 & 0 & 0 \\ 1 & 0 & 1 & 1 & 0 & 1 & 0 \\ 1 & 1 & 1 & 1 & 1 & 1 & 1 \\ 0 & 1 & 0 & 1 & 1 & 1 & 1 \\ 0 & 0 & 1 & 1 & 1 & 1 & 1 \\ 0 & 0 & 0 & 1 & 1 & 1 & 1\end{matrix} ] . \qquad [ Equation 10 ]$$

At this point, all relevant data required to execute the optimization algorithm is in the matrices D (a PGP dissimilarity matrix) and A₀ (a PGP adjacency matrix).

5. Execution of an Optimization Algorithm that Seeks to Globally Optimize the Objective Function

Returning to FIG. 5, for any number of desired partitions in the example illustrated, 1<K<7, (should the desired number of ISMAs be 1 or 7, then there would be no need to employ a hierarchical clustering since the entire geographic space (1), or the distinct PGPs (7) respectively would provide the obvious solutions), embodiments may be used to determine a suitable partitioning outcome that respects known spatial constraints (e.g., no PGPs may be merged unless they are adjacent and/or where the greatest distance between any two points interior to the merged polygons exceeds x miles), meets other (demographic) pre-defined non-industry goals (e.g., the median household income in any set of PGPs in a merged polygons must be no greater than $10,000), and also meets industry-specific goals (e.g., the sales in each ISMA must be roughly equal). Using these criteria, a similarity score will be determined, and the PGPs will then be merged based on similarity (for example, based on crossing a threshold of similarity).

Suppose, for example that, in one iteration where K=3 ISMAs was desired, PGP #1 may be merged with PGP #2, PGP #3, or PGP #4 (all of which are physically adjacent to PGP #1). Additionally, suppose that the largest distance between any arbitrary points in the polygon that would result by merging PGP #1 and PGP #3 exceeds a predefined constraint (greater than x miles, for example), then the only possible merges that could result for PGP #1 in this constrained environment would be PGP #2 and PGP #4.

Given other constraints (including multiple constraints), a determination is made as to whether the merging of (PGP #1 and PGP #2) or (PGP #1 and PGP #4) would meet the non-industry constraint (like the median household income difference of $10,000) and would result in a solution in which the industry-specific goals are better achieved. The merge choice would be the one in which was most consistent with the overall industry-specific goals.

Suppose the better choice was to merge (PGP #1 and PGP #2), which forms a temporary cluster referred to as Industry Specific Market Area #1 (MA #1) shown in FIG. 6. MA #1 is temporary for two reasons: (1) additional PGPs may be merged in later iterations; and (2) the merging of PGP #1 and PGP #2 may be a local optimum (in terms of meeting the industry-specific goals) and may be split in later iterations if it is inconsistent with a global optimum. That is, in some embodiments, some of the PGPs in already-merged MAs may be swapped out (or taken out) by the ISMA construction algorithm in a later iteration.

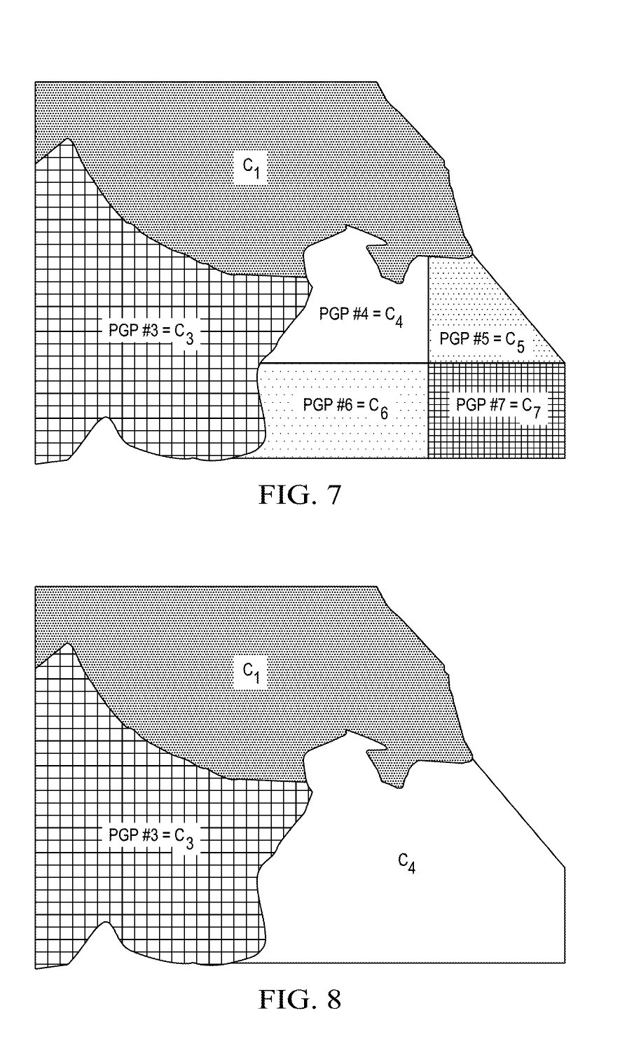

Execution of the optimization algorithm (which produces final ISMAs) can include: (1) A hierarchical clustering approach, given the loaded data D and A₀, for determining an initial set of K partitions (if possible to achieve K) denoted by Gₒ and measuring the value of the objective function; and (2) A refinement algorithm for generating t=1, . . . , T clustering outcomes Gₜ (t=1, . . . , T) to determine the clustering outcome G* which provides the optimal value of the objective function. If no improvements are made when moving from one iteration, t, to the next, t+1, the refinement algorithm is terminated and the best set of clustering outcomes (with respect to the objective function) is determined to be G*. In one embodiment, objective function optimization module 410 of system 400 may implement the optimization algorithm described herein. For the purpose of illustration and not of limitation, the hierarchical clustering approach and the refinement algorithm will now be described with reference to FIGS. 7-11.

5a. Initial Hierarchical Clustering, Gₒ

This process, which produces a set of ISMAs, is also referred to as a hierarchical PGP merging process. Beginning with each of the n PGPs representing its own cluster, the adjacencies between all PGPs are inspected to determine if a merge is allowable, given the constraint that no two clusters may merge unless they are physically adjacent. At this point, appropriate values of the adjacency matrix A₀ may be used to determine if the merge is allowable.

Next, the dissimilarities between every pair of clusters, Cₚ and C_{q}, that are allowable, given the adjacency matrix A₀, is computed as:

Π(Cₚ,C_{q})=Π(Cᵢ,Cⱼ)=dᵢⱼ [Equation 11]

Among all pairs allowed by the adjacency constraint, the clusters Cₚ and C_{q} which have the smallest value of Π(Cₚ, C_{q}) is found and clusters Π(Cₚ, C_{q}) are merged and assigned the same cluster index Cₚ and the height of the merge is set to Π(Cₚ, C_{q}). For example, suppose the smallest value of dᵢⱼ occurred between PGP #1 and PGP #2. The height of the merge is defined by Equation 9, Π(Cₚ, C_{q})=Π(Cᵢ, Cⱼ)=dᵢⱼ and both PGP #1 and PGP #2 are assigned to C₁ as shown in FIG. 7.

The adjacency matrix is updated so that after merge K, each element of Aₖ represents the maximum adjacency of the merges. Since C₁ is now composed of two PGPs (PGP #1 and PGP #2 shown in FIG. 5), the adjacency values are adjusted to reflect that both elements of C₁ are now available to be merged with any value in which either PGP is adjacent. The update adjacency matrix becomes:

$${A}_{1} = [ \begin{matrix}1 & 1 & 1 & 1 & + 1 & 0 & 0 \\ 1 & 1 & + 1 & 1 & 1 & 0 & 0 \\ 1 & + 1 & 1 & 1 & 0 & 1 & 0 \\ 1 & 1 & 1 & 1 & 1 & 1 & 1 \\ + 1 & 1 & 0 & 1 & 1 & 1 & 1 \\ 0 & 0 & 1 & 1 & 1 & 1 & 1 \\ 0 & 0 & 0 & 1 & 1 & 1 & 1\end{matrix} ] . \qquad [ Equation 12 ]$$

And the changes from 0 to 1 are marked with a + symbol.

After the first merge (among K−1 possible merges) of the PGP pairs with the smallest dissimilarity, the process is repeated with two minor modifications:
i. The distances between cluster is no longer necessarily evaluated using the individual dissimilarities, but is evaluated by the individual distances of all pairs represented in each pair of clusters

Π(Cₚ,C_{q})=max_{p,q}(Dₚ,D_{q}) [Equation 13]

where (Dₚ,D_{q}) contains the individual elements dᵢⱼ in the dissimilarity matrix based on pairwise elements, i and j, between every PGP in cluster p and every PGP in cluster q. For example, if after the first iteration PGP #1 and PGP #2 are joined, C₁ contains PGP #1 and PGP #2 while C₅ contains only PGP #5, then (C₁, C₅)=max(d_{1,5}, d_{2,5}).
ii. The adjacency matrix is again update based on the resulting merge—which may or not be among individual PGPs, but could be between a) clusters of PGPs and other clusters of PGPs or b) clusters of PGPs and unmerged standalone PGPs.

Once the height of next possible merge equals infinity (meaning that it is disallowed), clustering stops prior to that merge occurring and the initial partitioning, G₀, is determined and the value of the objective function for that clustering result is stored in V₀. If the resulting clusters, K′<K, then the constraints may need to be relaxed to allow the solution to become closer to K. With merges no longer possible—or if the target value of K has been reached—an example of a possible resulting partitioning outcome in shown in FIG. 8.

5b. Iterative Refinements to Gₒ

The above-described hierarchical clustering algorithm is quite computationally efficient, yet greedy in that it may have determined a local optimum of the objective function, rather than the more desirable global one. To overcome this complication, some embodiments employ an iterative approach that perturbs G₀ in a process called PGP swapping. In the iterative PGP swapping process, PGPs within a cluster that are adjacent to another cluster are removed from their original partition assignment and moved to the adjacent cluster to determine if the swap results in a clustering outcome that improves the measured value of the objective function.

It is noted that two special case of swapping may result: (a) PGP is separated from cluster and became its own cluster. Unless there is a corresponding merging of two other clusters, this will increase the total number of clusters; and (b) Two or more entire clusters may merge. Mechanically, this would be done using one PGP at a time until the resulting outcomes is that all PGPs in the cluster are merged with another.

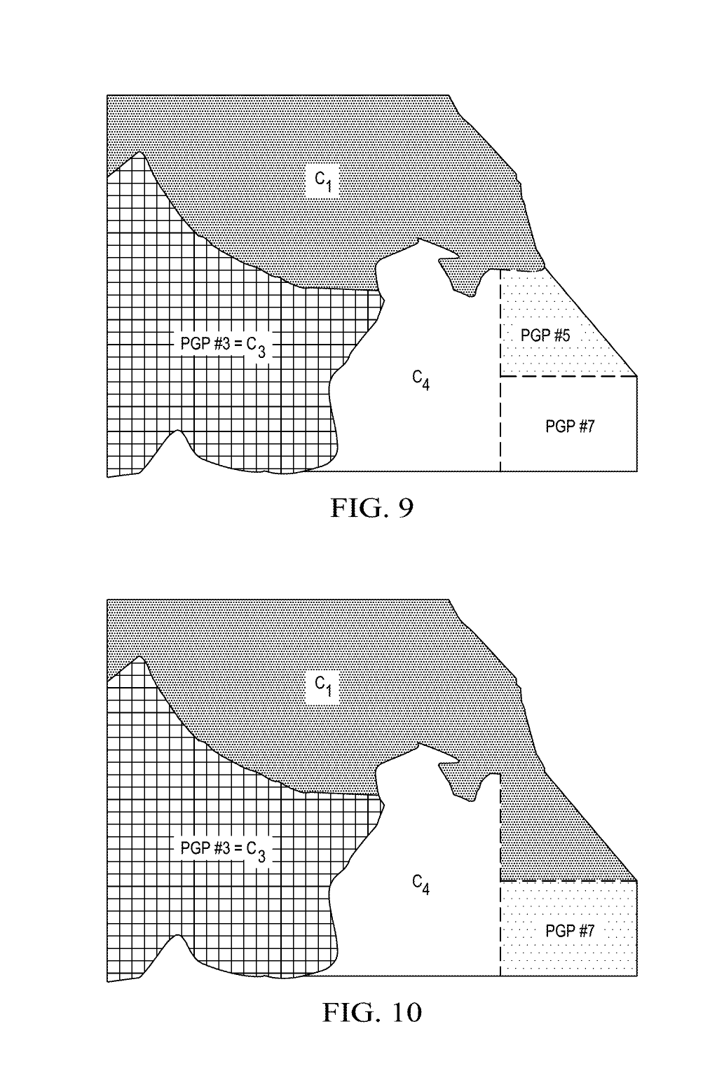

The process may require the following parameters:
A run length, T, is set which informs the process of how many passes it will make through the data as it seeks to improve the value of the objective function.
A cooling value, β, is set which determines the degree to which a new set of clusters will be considered a local improvement. The purpose of this parameter is to allow changes in the clustering outcome that do not initially appear to cause an improvement but rather to allow secondary changes to take effect that may lead to a more optimal value of the objective function. An example of how this might work can be illustrated by referring to FIG. 9 and assuming that that representation reflects G₀. Though the perturbation process might suggests that merging C₅ with C₁ may not lead to an improved outcome (with respect to the objective function), it is possible that the addition of C₇ (where it would not be possible without merging C₅ due to the adjacency constraint) would result in an improved outcome. Cooling allows such adjacent-to-adjacencies partitioning outcomes to be explored.
A stopping limit, ε, is set to allow early termination of the iterative process, if incremental improvements in the value of the objective are too small.
G₀ and V₀ are the starting point for the swapping process and its measured value of the objective function. These are stored and relabeled as G* and V*.
The preferred clustering outcome H* is stored where H*=G*=V₀.
Aₖ* is the adjacency matrix reflecting the merged polygons as reflected in G₀.

The process for t=1, . . . , T iterations works as follows:
1. At t=1, G₀ is compared with A₀ to find those PGPs in a cluster, Cₚ which are adjacent to another a PGP in another cluster C_{q}. This can be done by inspecting the rows of A₀ that correspond to elements of Cₚ and finding the column identifier, j, of A₀ that are equal to 1 and are not currently in Cₚ. These represent boundary PGPs which are on the periphery of Cₚ and adjacent to the clusters in which the j's belong. If the maximum distances between this PGP and the cluster to which it is considered adjacent is less than ρ, this represents a possible swap opportunities.
2. Every swap opportunity, f, is assigned a random uniform number drawn, u_{f,t} over a range of [0,1] and the swaps are evaluated in order of the rankings of the values of u_{f,t}. Note that it is possible that a PGP may be considered for a swap in more than one polygon if the A₀ indicates it is possible. In such cases, the values u_{f,t} can be modified so that they will immediately follow the other swap opportunities for the same PGP (secondarily ranked by their within-PGP values of u_{f,t}). The swaps are indicated by the triplet (PGPᵢ, Cₚ, C_{q}) indicating that PGPᵢ will be reassigned from Cₚ to C_{q}.
3. Each swap is conducted as follows:
   Each distinct PGP is reassigned to the cluster in which it is adjacent based on the information encoded in the swap triplet, the clustering outcome Gₜ(f) is computed and the value Vₜ(f) is computed. For example, in FIG. 9, since PGP #5 belongs to C₄ yet is adjacent to C₁ (by contrast, PGP #7 belongs to C₄ but is not physically adjacent to C₁), it is possible that the measured value of the objective function could be more favorable if that PGP #5 was removed from C₄ and into C₁. At this point, PGP #7 is not a candidate for swapping since it does not meet the adjacency requirement.
   If a PGP is eligible to be swapped with more than one cluster, the step is repeated for to yield a different outcome Gₜ(f′). The value of the objective function that is more optimal for that PGP, Vₜ(f*) is determined along with its clustering outcome Gₜ(f*).
   If Vₜ(f*) is an improvement over V*, the swapped clustering outcome is assigned to be the optimal value; the baseline clustering outcome becomes G*=Gₜ(f*), the optimal clustering outcome is set to H*=G*=Gₜ(f*), the optimal objective function value is set to V*=Vₜ(f*) and the adjacency matrix is updated to reflect the revised clustering outcomes.
   If Vₜ(f*) does not yield and improvement over V*, a random number, v, is drawn from a uniform distribution over the range [0,1]. If β/t<u, the baseline clustering outcome becomes G*=Gₜ(f*) and the adjacency matrix is update to reflect the revised clustering outcomes. Note that neither the optimal objective function value nor H* are updated in this case (as a better outcome has been observed). For example, if there was a decision to move PGP #5 into C₁ and out of C₄ (either because the objective function indicated this would be a better outcome or the random number draw allowed the swap to occur), then the clustering outcome shown in FIG. 10 would result.
4. This process is repeated over all swaps pertaining to iteration t.
5. t is incremented until t=T and, if the net change in the improvement in iterations t and t+1 is less than ε, the process is terminated.
6. After natural termination (after T iterations) or the stopping rule has been enforced, the value of H* is extracted and becomes the final clustering outcome that respects the define constraints, meets the targeted number of clusters K as well as can be allowed, and yields the most optimal value of the objective function among all configurations that were explored. The iterative improvement step is not bounded by the value of K that resulted in the initial clustering outcome. The improvement process may separate or merge clusters if it provides an overall more favorable outcome.

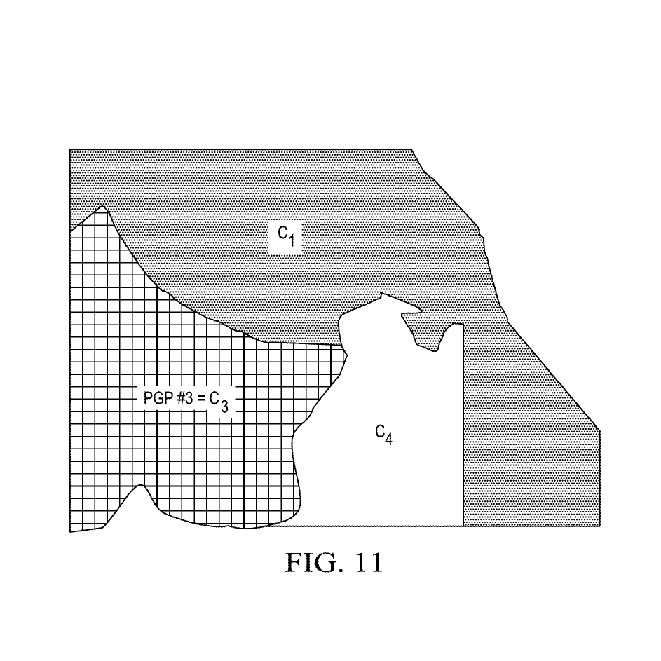

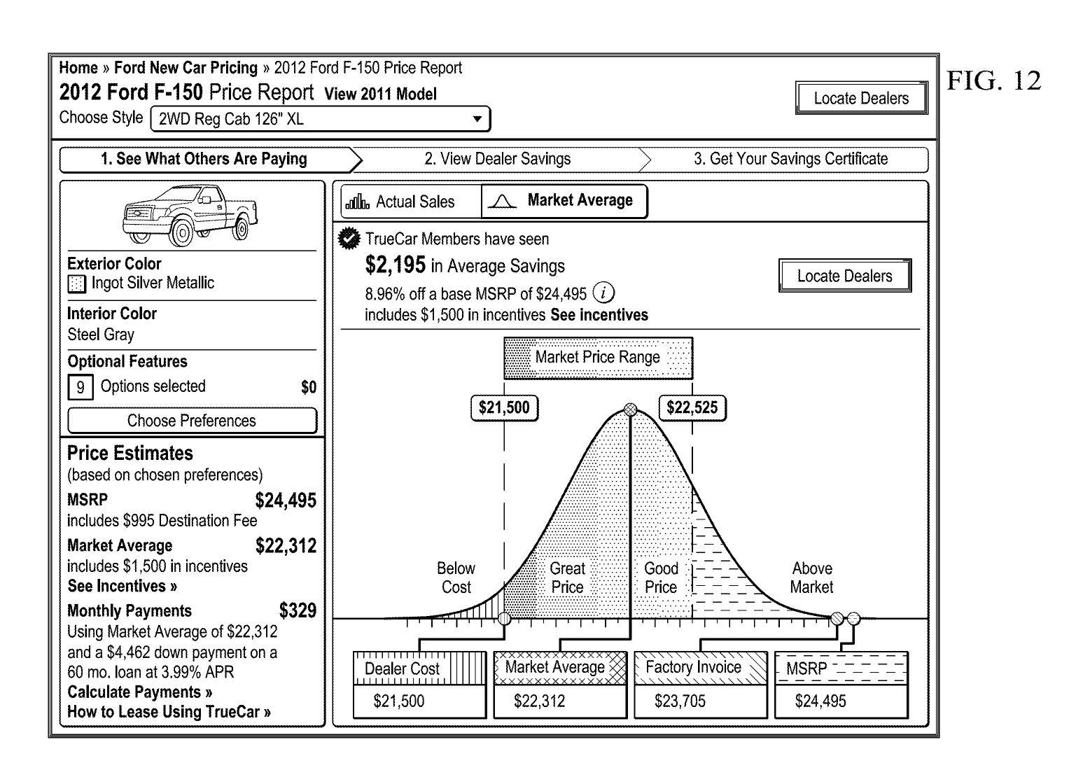

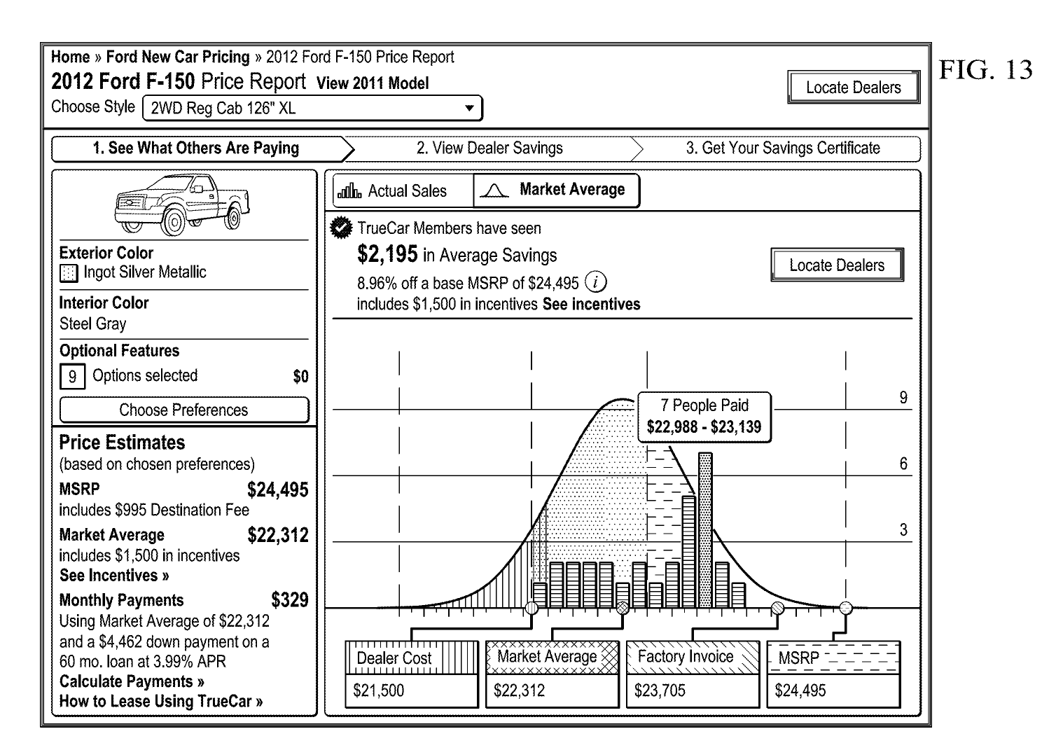

FIG. 11 provides a possible final clustering outcome that might result if it provides a more optimal outcome that G₀. Compared to FIG. 8, there are also K=3 clusters in FIG. 11, but PGPs #5 and #7 are now part of C₁ instead of C₄.

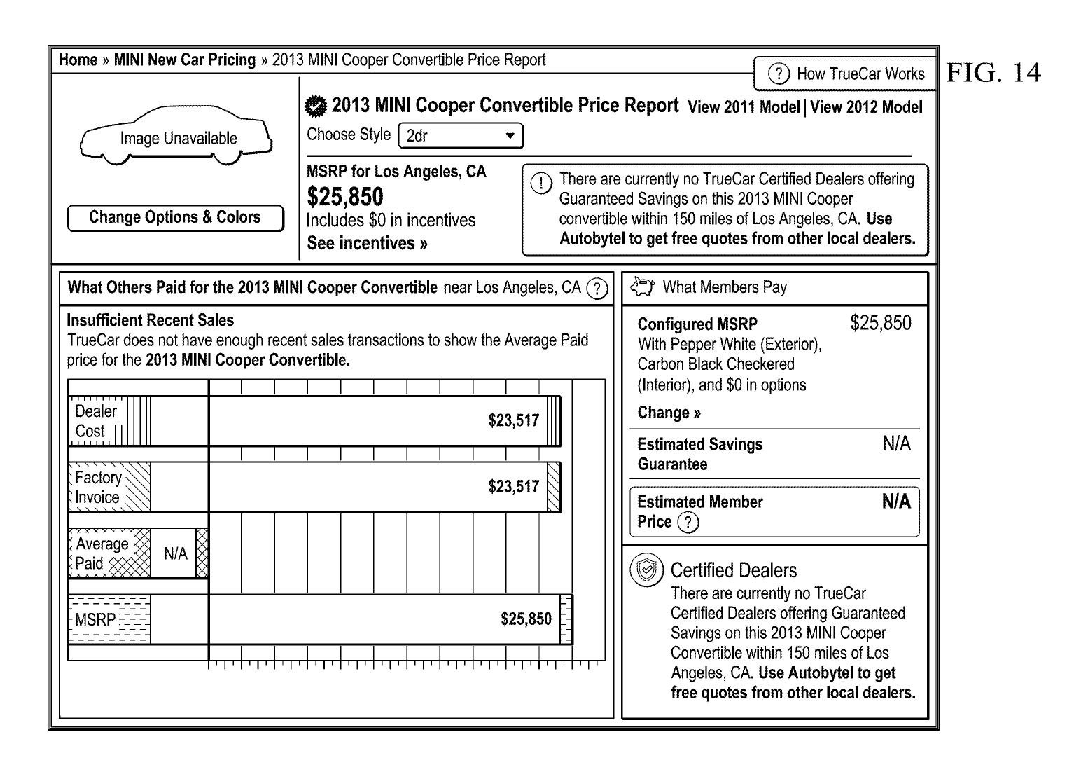

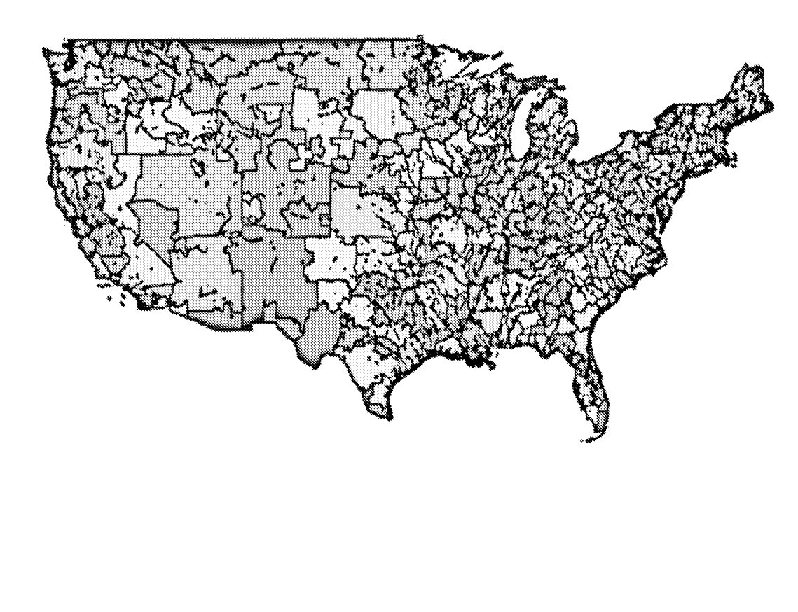

A specific use example powered by the TrueCar system described above will now be described with reference to FIGS. 12-14. In this example, the TrueCar system includes a TrueCar web site configured for providing competitive, upfront price quotes from a network of dealerships to web site visitors. An example user interface of the TrueCar web site is illustrated in FIG. 12. As demand for vehicles is realized through searches on the TrueCar website, a proprietary algorithm determines which dealers are displayed to the user along with the order in which they are displayed. Among the considerations of this proprietary algorithm is that upfront price quotes only reflect the prices of eligible dealers that are in the geographic proximity of the ZIP code requested in the search. Additionally, the TrueCar web site displays as a histogram of historical sales and prices for the make and model in the same “locality” as the ZIP code selected in the user's search. In one embodiment, “locality” was defined as a U.S. state. An example of a desirable case where a sufficient number of sales was available is illustrated in FIG. 13. However, this is not always possible. As illustrated in FIG. 14, using the state or DMA as the definition of “locality” may result an insufficient number of historical sales to present the sales histogram. Additional challenges in defining the “locality” include:
The reliability of the historical sales summary (the average prices, for example) was low due to insufficient volume.
Historical sales data indicated that buyers were willing to cross state lines to purchase a vehicle—that is, the administrative boundaries do not constrain buyer behavior.
Each manufacturer has its own definition of ‘local’ (a make-level region) which led to difficulty in comparing and summarizing industry-specific behavior in a uniform way.
The DMA was an insufficient solution for partitioning the U.S. for the automotive industry as their construction was meant to serve a different industry more constrained by broadcast range.
Geo-targeted marketing of particular vehicles could only be done at the state level (or at the regional level) as appropriate industry-specific partitions did not exist.

These limitations can be overcome using the ISMA methodology disclosed herein.

Specifically, in the example of the TrueCar system, the ISMA methodology was employed to build a partition of the land mass of the lower 48 states into 200 distinct ISMAs (Hawaii and Alaska are considered to be separate ISMAs). The choice of K=200 was made to remain consistent with a computing infrastructure that was scaled around the Nielson Designated Market Area (DMA) which have recently partitioned the U.S. land mass into between 190 and 210 DMAs. An objective function was built around the desire to boost quality and coverage (a partitioning that encompasses a sufficient number of historical sales so that the histogram could be displayed in all market areas). Since, in this case, the targeted usage of the resulting set of partitions was the automotive market, the term Automotive Market Area (AMA) is used in this example, instead of the more general Industry-Specific Market Area (ISMA).

In the construction of the AMAs, the 3-digit ZIP Code is used as the Primary Geographic Polygon (PGP), since this was the highest level of resolution for which industry-level data exists.

1. Extraction of Relevant Primary Geographic Polygon-Level Data

Spatial Data

The 3-digit ZIP Code polygon shape files were made available by the U.S. Census Bureau after the 2000 Decennial Census was conducted. These represent 960 distinct 3-digit ZIP codes that cover the entire US land mass. Additionally, to support the computation of distances between points, the latitude and longitude of the geo-centers of 5-digit ZIP Code Tabulation Areas (ZCTA) from the 2000 Census are used. Since the automotive industry is dependent on the U.S. road network for distribution of its products and services, drive distances between points in the AOI (the land mass of the lower 48 states) is extracted from MapQuest's Application Programming Interface.

Industry-Specific Data

The historical sales data for new vehicles was obtained from an information brokering service and broken out by vehicle segment (e.g. Truck/SUV, Luxury/Exotic, Other) and continent of origin (North America, Asia, Europe) to get the total number of sales. A sample of the transactions (representing about 10% of total new car purchases) is obtained at the 3-digit ZIP code level and then aggregated by vehicle segment and continent of origin c. The estimate of the total number of sales in 3-digit ZIP z for segment s and continent of origin then becomes:

$${\hat{N}}_{s , c , z} = \frac{{n}_{s , c , z}}{{\sum }_{Z = 1}^{Z} {n}_{s , c , z}} \times {N}_{s , c} \qquad [ Equation 14 ]$$

where n_{s,c,z} is the total sales in the sample data for segment s, continent c and 3-digit ZIP code z (z=1, . . . , Z) and N_{s,c} is the actual total number of sales (nationwide) for and segment s and continent s.

Additionally, for industry-specific data, the ratio of used car sales (regardless of continent and segment) to the total sales (new and used) is computed as:

$${R}_{Z} = \frac{{N}_{new}}{{N}_{new} + {N}_{used}} \qquad [ Equation 15 ]$$

Non-Industry-Specific Data

The data in this class is also drawn from the 2000 Census and includes 3-digit ZIP values for:
b₁: Median household income (in 2000 dollars)
b₂: Median home Price (in 2000 dollars)
b₃: Percent of households owning home
b₄: Labor Force Participation (age 16 and older)
b₅: Percent population residing in urban areas

2. Identification of Relevant Constraints (Λ)

The inflexible constraint is applied stating that no 3-digit ZIP polygons may be merged unless they have a queen-level adjacency. The other constraints are:
1. Merges which would results in an inter-cluster driving distance greater than ρ=150 miles are prohibited.
2. The maximum percent difference in the percent population residing in urban areas is 20%. This constraint disallows expansion of AMAs beyond urban areas into rural areas where the vehicles types tend to differ dramatically. Generally, a larger percentage of SUVs and trucks are found in rural areas.
3. Definition of the Objective Function

An objective here is to create partitions which have at least 20 transactions per year/make/model/trim (indexed by v) combinations per week. This may reduce the number of cases where a histogram has insufficient data to be displayed on the TrueCar web site while simultaneously decreasing estimation error. If an outcome variable I is defined as:

$${I}_{k , v , w = \{ \begin{matrix}1 & if there are least 20 transactions for partion k of trim v i n week w \\ 0 & otherwise\end{matrix}} \qquad [ Equation 16 ]$$

The objective function to be maximized becomes:

$$V = \frac{{Σ}_{k} {Σ}_{v} {Σ}_{w} {I}_{k , v , w}}{K} \qquad [ Equation 17 ]$$

4. Transformation and Loading of Data

Given the constraints and spatial data, the classes of data are transformed and loaded. First, the maptools library of the R program is used to create a queen-level adjacency with a snap of 100 meters.

The driving distance between the geocenters of every 5-digit ZCTA within a 3-digit ZIP are compared to the geocenters of every 5-digit ZCTA in all other 3-digit ZIP. For each 3-digit pair, the maximum distance is computed and reflects the dissimilarity along the distance dimension. Before converting each variable into a dissimilarity value, some are rescaled:
The between-ZIP3 driving distances are rescaled by diving by the maximum amount (150) miles so that the rescaled amounts lie between 0 and 1.
Each vehicle segment/continent of origin sales value is rescaled to be N*_{s,c,z}= N̅_{s,c,z}/ N̅_{z} where N̅_{z} is the total number of estimated sales in 3-digit ZIP z so they all lie between 0 and 1.
Median household income and median home prices are rescaled over [0,1] and the constraint is rescaled accordingly.

Dissimilarities are then computed for each dimension—with the exception of the constraint on the urbanicity variable, b₅, and the driving distance (the constraint is now set to 1 since they have been rescaled), no constraints apply.

$${d}_{ij , r} = \{ \begin{matrix}\vert {x}_{i , r} - {x}_{j , r} \vert & if \vert {x}_{i , r} - {x}_{j , r} \vert \leq {λ}_{r} \\ ∞ & if \vert {x}_{i , r} - {x}_{j , r} \vert > {λ}_{r}\end{matrix} \qquad [ Equation 18 ]$$

There are now 1 spatial variable (driving distances), 10 industry-specific variables (9 vehicle segment/continent combinations and R_{z}) and 5 non-industry specific variables (b₁-b₅), for a total of 16 dimensions. The composite dissimilarity is then computed as

dᵢⱼ=[Σᵣ₌₂^{m}wᵣd_{ij,r}^{γ}]^{1/γ} [Equation 19]

Using γ=2 with the weights shown in Table 2 below.

TABLE 2
Variable weights

| r | Class | Variable | w |
|---|---|---|---|
| 2 | Spatial | Drive Distances | 0.10 |
| 3 | Industry | Percent of Sales, North America Truck/SUV | 0.045 |
| 4 | Specific | Percent of Sales, North America Luxury/Exotic | 0.045 |
| 5 | | Percent of Sales, North America Other | 0.045 |
| 6 | | Percent of Sales, Europe Truck/SUV | 0.045 |
| 7 | | Percent of Sales, Europe Luxury/Exotic | 0.045 |
| 8 | | Percent of Sales, Europe Other | 0.045 |
| 9 | | Percent of Sales, Asia Truck/SUV | 0.045 |
| 10 | | Percent of Sales, Asia Luxury/Exotic | 0.045 |
| 11 | | Percent of Sales, Asia Other | 0.045 |
| 12 | | R_{z}: Percent New Cars Sales | 0.045 |
| 13 | Non-Industry | b₁: Median household income (in 2000 dollars) | 0.09 |
| 14 | Specific | b₂: Median home Price (in 2000 dollars) | 0.09 |
| 15 | | b₃: Percent of households owning home | 0.09 |
| 16 | | b₄: Labor Force Participation (age 16 and | 0.09 |
| | | older) | |
| 17 | | b₅: Percent population residing in urban areas | 0.09 |
| | | TOTAL | 1.00 |

5. Execution of an Optimization Algorithm that Seeks to Globally Optimize the Objective Function

With a T=50 iterations and a cooling factor of β=0.5 and a stopping limit of ε=0.0001, the optimal value of the objective function was found. Given the data and the constraints, a better partition solution existed for 188 AMAs (vs. the desired 200). The final outcome of 188 AMAs is shown in FIG. 15.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, touch pad, etc.), or the like.

ROM, RAM, and HD are computer memories for storing computer-executable instructions executable by the CPU or capable of being complied or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used, individually or in conjunction with another programming language, to implement the routines, methods or programs of embodiments of the invention described herein, including C, C++, Java, JavaScript, HTML, or any other programming or scripting language, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed is:

1. A method for determining industry-specific market areas, comprising:
extracting, by a vehicle data system running on one or more server machines from one or more sources communicatively connected to the vehicle data system, relevant primary geographic polygon-level data for a set of primary geographic polygons (PGPs) covering an area of interest;
transforming and loading, by the vehicle data system, the extracted relevant primary geographic polygon-level data for the set of PGPs into a PGP similarity/dissimilarity matrix with respect to industry-specific constraints and non-industry-specific constraints and a PGP adjacency matrix with respect to spatial constraints; and
executing, by the vehicle data system, an optimization algorithm to globally optimize a predefined industry-specific objective function;
wherein the optimization algorithm comprises a hierarchical PGP merging process and an iterative PGP swapping process;
wherein the hierarchical PGP merging process is configured for merging each pair of physically adjacent PGPs in the set of PGPs utilizing the PGP similarity/dissimilarity matrix and updating the PGP adjacency matrix iteratively until a stopping condition is met, the hierarchical PGP merging process producing a set of industry-specific market areas (ISMAs); and
wherein the iterative PGP swapping process is configured for adjusting the set of ISMAs such that a best possible outcome for the predefined industry-specific objective function is achieved.

2. The method according to claim 1, wherein each PGP in the set of PGPs represents a smallest geographic unit for which spatial data, industry-specific data, and non-industry specific data are available to the vehicle data system.

3. The method according to claim 1, wherein the hierarchical PGP merging process further comprises:
inspecting all PGPs in the set of PGPs to determine if a merge is allowed, given a spatial constraint that no two PGPs are allowed to merge unless they are physically adjacent.

4. The method according to claim 3, wherein the hierarchical PGP merging process further comprises:
among all pairs of PGPs allowed by the spatial constraint to merge, merging a pair of PGPs that are least dissimilar or most similar.

5. The method according to claim 1, wherein the adjusting the set of ISMAs further comprises:
removing, from a first ISMA, one or more PGPs within the first ISMA that are adjacent to a second ISMA;
moving the one or more PGPs to the second ISMA; and
determining if the set of ISMAs thus adjusted improves a measured value of the predefined industry-specific objective function.

6. The method according to claim 1, wherein the set of ISMAs is adjusted via the iterative PGP swapping process a predetermined number of iterations or until a stopping condition is met.

7. The method according to claim 1, wherein the set of ISMAs achieving the best possible outcome for the predefined industry-specific objective function is fixed and not dynamically updated by the vehicle data system.

8. A system for determining industry-specific market areas, comprising:
at least one processor; and
at least one non-transitory computer readable medium storing instructions executable by the at least one processor for:
extracting, from one or more sources communicatively connected to the system, relevant primary geographic polygon-level data for a set of primary geographic polygons (PGPs) covering an area of interest;
transforming and loading the extracted relevant primary geographic polygon-level data for the set of PGPs into a PGP similarity/dissimilarity matrix with respect to industry-specific constraints and non-industry-specific constraints and a PGP adjacency matrix with respect to spatial constraints; and
executing an optimization algorithm to globally optimize a predefined industry-specific objective function;
wherein the optimization algorithm comprises a hierarchical PGP merging process and an iterative PGP swapping process;
wherein the hierarchical PGP merging process is configured for merging each pair of physically adjacent PGPs in the set of PGPs utilizing the PGP similarity/dissimilarity matrix and updating the PGP adjacency matrix iteratively until a stopping condition is met, the hierarchical PGP merging process producing a set of industry-specific market areas (ISMAs); and
wherein the iterative PGP swapping process is configured for adjusting the set of ISMAs such that a best possible outcome for the predefined industry-specific objective function is achieved.

9. The system of claim 8, wherein each PGP in the set of PGPs represents a smallest geographic unit for which spatial data, industry-specific data, and non-industry specific data are available to the system.

10. The system of claim 8, wherein the hierarchical PGP merging process further comprises:
inspecting all PGPs in the set of PGPs to determine if a merge is allowed, given a spatial constraint that no two PGPs are allowed to merge unless they are physically adjacent.

11. The system of claim 10, wherein the hierarchical PGP merging process further comprises:
among all pairs of PGPs allowed by the spatial constraint to merge, merging a pair of PGPs that are least dissimilar or most similar.

12. The system of claim 8, wherein the adjusting the set of ISMAs further comprises:
removing, from a first ISMA, one or more PGPs within the first ISMA that are adjacent to a second ISMA;
moving the one or more PGPs to the second ISMA; and
determining if the set of ISMAs thus adjusted improves a measured value of the predefined industry-specific objective function.

13. The system of claim 8, wherein the set of ISMAs is adjusted via the iterative PGP swapping process a predetermined number of iterations or until a stopping condition is met.

14. The system of claim 8, wherein the set of ISMAs achieving the best possible outcome for the predefined industry-specific objective function is fixed and not dynamically updated by the system.

15. A computer program product comprising at least one non-transitory computer readable medium storing instructions executable by a computer for:
extracting, from one or more sources communicatively connected to the computer, relevant primary geographic polygon-level data for a set of primary geographic polygons (PGPs) covering an area of interest;
transforming and loading the extracted relevant primary geographic polygon-level data for the set of PGPs into a PGP similarity/dissimilarity matrix with respect to industry-specific constraints and non-industry-specific constraints and a PGP adjacency matrix with respect to spatial constraints; and
executing an optimization algorithm to globally optimize a predefined industry-specific objective function;
wherein the optimization algorithm comprises a hierarchical PGP merging process and an iterative PGP swapping process;
wherein the hierarchical PGP merging process is configured for merging each pair of physically adjacent PGPs in the set of PGPs utilizing the PGP similarity/dissimilarity matrix and updating the PGP adjacency matrix iteratively until a stopping condition is met, the hierarchical PGP merging process producing a set of industry-specific market areas (ISMAs); and
wherein the iterative PGP swapping process is configured for adjusting the set of ISMAs such that a best possible outcome for the predefined industry-specific objective function is achieved.

16. The computer program product of claim 15, wherein each PGP in the set of PGPs represents a smallest geographic unit for which spatial data, industry-specific data, and non-industry specific data are available to the computer.

17. The computer program product of claim 15, wherein the hierarchical PGP merging process further comprises:
inspecting all PGPs in the set of PGPs to determine if a merge is allowed, given a spatial constraint that no two PGPs are allowed to merge unless they are physically adjacent.

18. The computer program product of claim 17, wherein the hierarchical PGP merging process further comprises:
among all pairs of PGPs allowed by the spatial constraint to merge, merging a pair of PGPs that are least dissimilar or most similar.

19. The computer program product of claim 15, wherein the adjusting the set of ISMAs further comprises:
removing, from a first ISMA, one or more PGPs within the first ISMA that are adjacent to a second ISMA;
moving the one or more PGPs to the second ISMA; and
determining if the set of ISMAs thus adjusted improves a measured value of the predefined industry-specific objective function.

20. The computer program product of claim 15, wherein the set of ISMAs is adjusted via the iterative PGP swapping process a predetermined number of iterations or until a stopping condition is met.
